(19) United States
(12) Patent Application Publication
(10) Pub. No.: US 2017/0293883 A1
(43) Pub. Date: Oct. 12, 2017

(54) Package Security Device

(71) Applicant: Jianhua Li, Fremont, CA (US)

(72) Inventors: Jianhua Li, Fremont, CA (US); David H. Horn, Saratoga, CA (US)

(21) Appl. No.: 15/093,740

(22) Filed: Apr. 8, 2016

(51) Int. Cl. G06Q 10/08; G08B 13/196; H04L 12/58; H04W 76/02; G06K 7/14; H04W 68/00

(52) U.S. Cl. CPC G06Q 10/0832; G06K 7/1408; H04W 68/005; H04L 51/046; G06Q 10/0833; H04W 76/02; G08B 13/196; H04W 84/12

(57) ABSTRACT

A Package Security Device senses delivery person's terminal device (or called mobile computer), triggers a camera to monitor the delivered package. When an unknown animal or a person approaches to the package, it captures and stores images, and generates warning sounds. The device can also send receipt confirmation message to the delivery person's terminal device, and/or the shipping company's data center as well as the package recipient through wireless communication.

### BACKGROUND OF THE INVENTION

An increasing number of people shop online. These purchases are typically packaged and shipped to the purchasers' residence. With many people working away from their homes, many deliveries are made unattended, to locations where a responsible person is not at home or available to receive and secure these packages.

Currently, there are no stand-alone products on the market that provide automated acknowledgement to the delivery person and package recipient of package deliver, acknowledgement to the package recipient of a missed package delivery or the removal of a delivered package

We are describing a device for providing electronic acknowledgement of the receipt of a delivered package and a means for monitoring the position of the delivered package until the package recipient takes possession of the package.

### BRIEF SUMMARY OF THE INVENTION

Delivered package without signature requirement can't be secured and packages that require a signature may require multiple delivery attempts to secure a signature or the pickup will be deferred to the shipping companies' service center if no one is available to provide the signature at the residence. This Package Security Device (or called PSD in this disclosure) can solve these problems and save time for both delivery service person and package recipient.

When a shipping company delivery person comes to the residence, and finds no one to sign the receipt of the package, he/she leaves the package at the residence, and establishes wireless communication with the PSD by methods described in the section of “DETAILED DESCRIPTION OF THE INVENTION”. The delivery person's terminal device sends package information to the PSD, and/or the owner's cell phone. After the delivery person leaves, the PSD monitors the package, and generates beeping sounds when necessary, until the owner comes home to turn it off.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 illustrates an example of an embodiment of various embodiments of the present invention

FIG. 2 illustrates an example of a functional block diagram of various embodiments of the present invention

FIG. 3 illustrate an example of a block diagrams of the flow processes according to various embodiments of the present invention

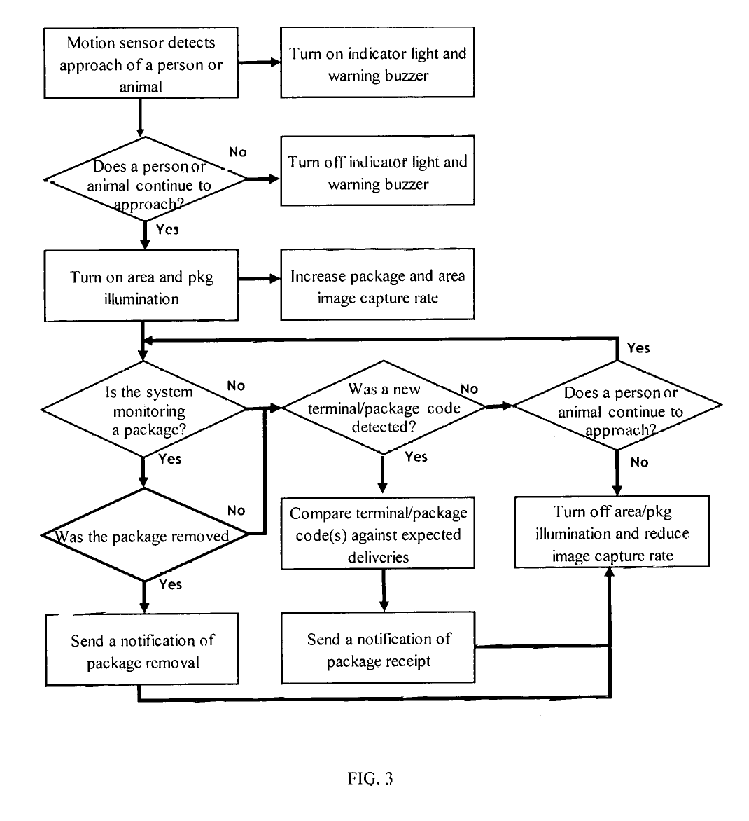

### DETAILED DESCRIPTION OF THE INVENTION

As used herein, the singular forms “a”, “an”, and “the” are intended to include the plural forms as well, unless the context clearly indicates otherwise. It will be further understood that the terms “composed of”, “comprised of”, “comprises” and/or “comprising” when used in this disclosure, specify the presence of stated features, steps, elements, and/or components, but do not preclude the presence or addition of one or more other features, steps, elements, components, and/or groups thereof. The term “and/or” includes any and all combinations of one or more of the associated listed items.

The term “package” used in this disclosure can be understood as “parcel”, “enveloped mail”, “shipping box”, or “shipping canton” etc. The term “barcode” used in this disclosure can be “one-dimension barcode”, “1D barcode”, “two-dimension barcode”, or “2D barcode”. The terms “owner”, “homeowner”, or “owner of the PSD” used in this disclosure can be understood as the “recipient of the package”. The terms “a camera”, “camera”, “the camera”, or “camera module” are intended to include multiple cameras to take pictures of object at different directions. Further, the terms “a camera”, “camera”, “the camera”, or “camera module” can be understood as multiple regular cameras in combination with one or multiple infrared (or called IR) cameras, to be able to take pictures at bright or dark ambient light conditions. The term “terminal device” used in this disclosure can be understood as “mobile computer”, which is commonly used by shipping companies' delivery person to read barcode of package and record signature of the recipient. This “terminal device” usually has a built-in barcode scanner and has capability of wireless communication.

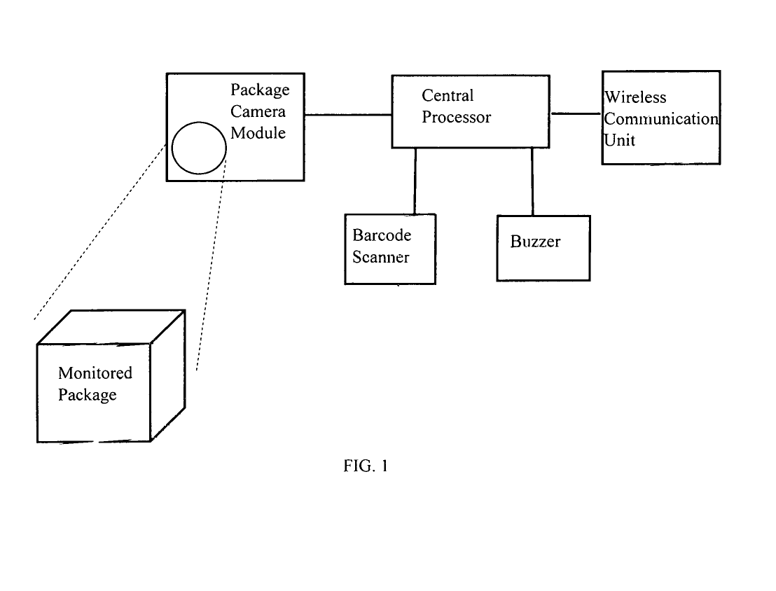

The PSD is typically a wall or post mount device with components that have the capability of detecting approaching people or animals to a person's door where the device is installed. The PSD in one exemplary form comprises a Package Camera Module, a Barcode Scanner or an RFID sensor (radio-frequency identification sensor), a Buzzer, a Wireless Communication Unit, a Central Processor, as shown in FIG. 1.

The Package Camera Module has a field of view to cover typical maximum package size, as it looks from its installed wall mount position to the designated drop-off area for the delivered package

The Barcode Scanner reads bar code and sends the barcode information to the central processor. If the package camera module has high resolution and appropriate software to analyze image and recognize barcode inside the captured image, it can be used both to take pictures and to read barcode. In that case, the barcode scanner is not needed in PSD. In another configuration, this barcode scanner can be augmented or replaced with a RFID sensor which can sense RFID.

The Buzzer makes a noise when something is detected and approaching the package drop off area. This serves as a location indicator to someone wanting to drop off a package and as a warning that the package is being monitored to someone potentially wanting to steal the package or an animal approaching the package.

The Wireless Communication Unit can be connected and communicate over Wi-Fi frequencies to a local WLAN (Wireless Local Area Network), and/or be connected and communicate over cellular phone frequencies to local cellular phone networks. It allows the PSD to communicate with the owner's cell phone, the package delivery person' terminal device and the shipping company's data center to exchange information among the four devices.

The Central Processor can be installed outside of the residence, or inside of the residence, or located remotely to reduce installation cost and increase device security. The central processor controls and coordinates the package camera module, the barcode scanner (and/or RFID sensor), the buzzer, and the wireless communication unit.

Through initial installation, the PSD can be wirelessly connected and controlled by owner's cell phone. Further, the PSD can be registered in shipping companies' data centers using PSD IP address or owner's cell phone number, so that message can be wirelessly communicated between the PSD and shipping companies' data centers, with or without the PSD owner's cell phone as the medium.

In one example of usage of this PSD, a delivery person comes to the receiver's residence, scans the barcode of the package using his/her terminal device, places the package in the designated drop-off area that can be viewed by the PSD package camera, holds his/her terminal device to the PSD barcode scanner. There is a pre-defined barcode (or RFID) attached to the delivery person's terminal device, which is the unique ID of this terminal device. After the PSD barcode scanner scans the unique barcode of the delivery person's terminal device (or the PSD RFID sensor senses the unique RFID of the terminal device), the PSD uses this unique ID information to establish wireless communication with this particular terminal device. The information of the delivered package (including but not limited to track number of this shipment, barcode of the package, and/or brief description of the content inside the package) is wirelessly sent from the delivery person's terminal device to the PSD and/or the PSD owner's cell phone. The PSD central processor orders the package camera module to take a picture of the package sitting in the drop-off area. A message confirming delivery of the package, with or without the picture, can be wirelessly sent from the PSD to the delivery person's terminal device and/or to the shipping company data center. The delivery person stores this delivery confirmation message, and leaves.

In a second example of usage of this PSD, the delivery person's terminal device may not have a pre-defined barcode (or RFID) as a-unique ID of this terminal device. Instead, the PSD installed at the owner's residence has a pre-defined barcode (or RFID) as a unique ID of this PSD. The usage scenario can be as follows. A delivery person comes to the receiver's residence, scans the barcode of the package using his/her terminal device, places the package in the designated drop-off area that can be viewed by the PSD package camera, then scans the unique barcode of the PSD using his/her terminal device, or senses the unique RFID of the PSD using his/her terminal device. The delivery person's terminal device uses this unique ID information to establish wireless communication with this particular PSD. The information of the delivered package (including but nor limited to track number of this shipment, barcode of the package, and/or brief description of the content inside the package) is wirelessly sent from the delivery person's terminal device to the PSD and/or the PSD owner's cell phone. The PSD central processor orders the package camera module to take a picture of the package sitting in the drop-off area. A message confirming delivery of the package, with or without the picture, can be wirelessly sent from the PSD to the delivery person's terminal device and/or to the shipping company data center. The delivery person stores this delivery confirmation message, and leaves.

Other delivery acknowledgements are possible with the addition of a software application to the PSD owner's cell phone or computer, where emails from package supplier with information confirming purchases that contain shipping alerts can be logged by date and time range of intended delivery, track number, number of packages, barcode of the package(s), and/or brief description of the content inside the package(s) number of items delivered. If a package is received the bar code can be compared against the expected deliveries to see if the package was expected. The owner will receive a confirmation of package delivery or a confirmation of expected package delivery depending if the package was expected or not. Conversely at the end of the expected delivery time, if no package was received the homeowner will receive a notification of a missed delivery.

In a third example of usage of this PSD, there are no barcode (or RFID) as a unique ID for each or both of the delivery person's terminal device and the PSD, or the barcode is assigned but will not be used in the delivery process. Before the delivery person comes, the shipping company data center already sends “notice of expected package delivery” (including but not limited to track number of this shipment, barcode of the package, brief description of the content inside the package, and estimated delivery time) wirelessly through the cell phone or computer application to the PSD and/or to the owner's cell phone. When the delivery person comes to the receiver's residence, he/she scans the barcode of the package using his/her terminal device, places the package in the designated drop-off area that can be viewed by the PSD package camera. The PSD package camera always continuously monitors the designated drop-off area. As long as it recognizes a barcode in its viewing area that matches the one in the “notice of expected package delivery”, it takes a frame of picture of such. The PSD then establishes wireless communication with the delivery person's terminal device, with or without the shipping company's data center as the medium. A message confirming delivery of the package, with or without the picture, can be wirelessly sent from the PSD to the delivery person's terminal device and/or to the shipping company data center. The delivery person stores this delivery confirmation message, and leaves.

After the delivery person leaves, the package camera module keeps monitoring the package, taking pictures at certain frequency of time (i.e. every second). By doing imaging processing, ii the package camera module finds current picture is appreciably different from last picture, the central processor will activate the buzzer to beep for some period of time to drive away a potential thief or a curious animal, and may also send warning signals to the homeowner's cell phone. The image capture rate can be increased should it detect package movement. These images are stored and may be used afterwards as proof for police office in case of theft. If on one approaches to the package, the package camera module keeps monitoring the package quietly until the owner comes to retrieve the package. The owner uses his/her cell phone or a switch inside the residence to turn off the package camera module and meanwhile sends out the receipt confirmation to the shipping service company. If not used for package monitoring, this PSD can also be used as home security alarm device, recording image of changes and activity wherever it is installed.

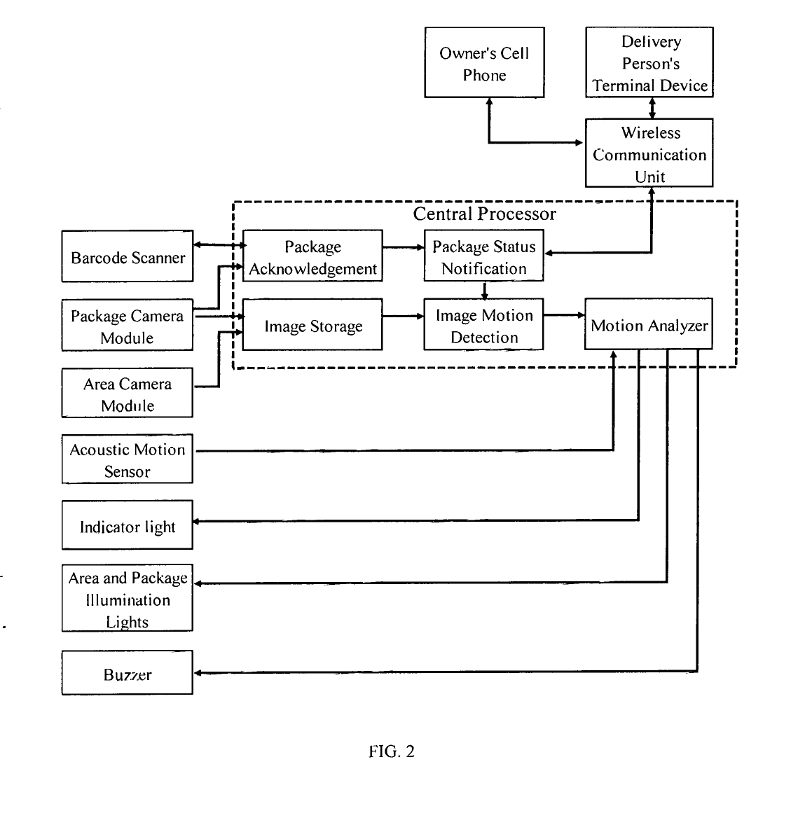

The PSD in other exemplary forms can be added with an Area Camera Module, an Acoustic Motion Sensor, an Indicator Light, a Package Illuminator, and an Area Illuminator, to have more functionality while monitoring the delivered package sitting in the designated drop-off area, as shown in FIG. 2.

The Area Camera Module should have enough Field of View to capture area images of people or animals which may approach the package and disturb its position.

The Acoustic Motion Sensor is an acoustic speaker and microphone module to output sound and detect reflected sound in order to estimate time of flight distance measurement of approaching person or animal. The acoustic sensor would be used as a motion detector which can provide early detection of approaching people or animals and can be used in confirming image motion detection decisions. Other sensors may be incorporated which sense and in some cases record RFID, Wi-Fi, . . . which may be in proximity to the PSD.

The Indicator Light illuminates when something is detected and approaching the package drop off area. This serves as a location indicator to someone wanting to drop off a package and as a warning that the package is being monitored to someone potentially wanting to steal the package.

The Package Illuminator serves as a location indicator to someone wanting to drop off a package. The illuminator identifies the bar code scan location for someone dropping off the package as well as illumination enabling the monitoring the package position while the device is providing security.

The Area Illuminator enables the camera device to be able to capture security images. This may to capture a person or animal approaching or if a package moves, etc.

The Central Processor can be comprised of elements including but not limited to the following five elements. Some or all of these elements may reside at the installation point or located remotely from the detection, warning and illumination portion of the device.

Image Storage acts as a repository of images, bar code, package position and area images.

Package Acknowledgement identifies the package was scanned and placed within the security image view.

Image motion detection compares package images to determine movement of the package(s)

Package Status Notification receives incoming information about packages that are expected for delivery from homeowner's smart phone or computer emails, receives information about packages that are scanned and received and receives notifications if packages are moved. The Package Status Notification also sends notifications to the package recipient (expected package not received, expected package received, new package received, package moved).

The Motion Analyzer takes the image motion data and applies a level of motion sensitivity to determine if the package is moving slightly or if the package disappeared

With these added components in the PSD structure as shown in FIG. 2. If a person or animal approaches the PSD, the PSD may have the capability to detect the approach through image analysis or the use of sensors, acoustic, RFID, Wi-Fi, . . . The approach can turn on the indicator light and warning buzzer. A delivery person would then use these notices to locate the PSD, to be able to make the secure delivery. An unwanted individual or animal could react to this unwanted detection of its presents and retreat to a safe distance.

If the person continues to approach the PSD, it will illuminate the package drop-off area. This will help the delivery person properly locate the package designated drop-off area. In some situations, an area illumination source will also be initiated with the continued approach by a person or animal. This will allow the area image to be properly lighted and images recorded for security purposes.

If the PSD detects a person or animal approaching and the PSD has not started monitoring a package, then the PSD will increase its image capture rate looking for a bar code on the package. If the barcode on the package is recognized, it will be captured, stored and an acknowledgement will be sent to the delivery person's terminal device and package recipient's cell phone. The PSD will then capture an image of the package in the drop-off area and begin monitoring its position and send a message of delivery confirmation to the delivery person' terminal device and the package recipient's cell phone.

We claim:

1. A package security device comprising:
a) a package camera module for capturing images of package;
b) a wireless communication unit for providing wireless communication; and
c) a central processor unit for providing control and coordination.

2. The device in claim 1, wherein the wireless communication unit provides communication to at least one of:
a) wireless local area network; or
b) local cellular phone network.

3. The device in claim 1 that is powered by at least one of:
a) battery;
b) mains power; or
c) solar power.

4. The device in claim 1, wherein the wireless communication unit can communicate between the central processor and an external device, the external device comprising at least one of:
a) the device owner's cell phone;
b) the device owner's computer;
c) shipping company delivery person's terminal device; or
d) shipping companies' data center.

5. The device in claim 1 that is wirelessly connected with the device owner's cell phone through initial installation of the device, and is wirelessly controlled by the device owner's cell phone.

6. The device in claim 1, further comprising a buzzer for making a noise.

7. The device in claim 6, further comprising a barcode scanner for reading barcode information.

8. The device in claim 7, further comprising a radio-frequency identification sensor for sensing radio-frequencies.

9. The device in claim 8, further comprising an acoustic sensor for sensing the approach of a person or animal.

10. The device in claim 9, wherein a unique barcode is assigned to the device.

11. The device in claim 10, wherein a unique radio-frequency identification is assigned to the device.

12. The device in claim 11, wherein an internet protocol address is assigned to the device.

13. The device in claim 12 that is wirelessly connected with shipping companies' data centers through registration using the device's internet protocol address or the device owner's cell phone number.

14. The device in claim 12, wherein a software application is installed to facilitate the communication among the device, the device owner's cell phone, and the device owner's computer; and the software application can decode emails sent from the shipping company to the device owner's cell phone or computer, translate this email as the notice of expected package delivery, and send the notice of expected package delivery to the device; information of the notice of expected package delivery comprising at least one of:
a) date and time range of intended delivery;
b) number of packages shipped;
c) track number of each package;
d) description of the content inside each package; or
e) barcode of each package.

15. The device in claim 12, wherein the central processor has the functions comprising at least one of:
a) storing images, bar codes, package positions and area images;
b) identifying the package that was scanned and placed down;
c) comparing package images to determine movement of the package;
d) receiving information about packages that are expected for delivery from device owner's cell phone or computer;
e) receiving information about packages that are delivered;
f) sending notifications and information of the package to the package recipient; or
g) recording and storing the image motion data and applying a level of motion sensitivity to determine if the package is moving slightly or if the package disappeared.

16. The device in claim 12, wherein the package camera module is triggered to take a picture of the package by at least one step of:
a) the barcode scanner reading the unique barcode of the delivery person's terminal device;
b) the radio-frequency identification sensor sensing the unique radio-frequency identification of the delivery person's terminal device;
c) the delivery person's terminal device reading the unique barcode of the package security device as described in claim 10;
d) the delivery person's terminal device sensing the unique radio-frequency identification of the package security device as described in claim 11; or
e) the package camera module recognizing a barcode in its viewing area that matches the barcode in the notice of expected package delivery as described in claim 14.

17. The device in claim 12, wherein the package camera module starts monitoring delivered package when the package delivery confirmation message is sent from the package security device to the delivery person's terminal device

18. A method of establishing wireless communication between the package security device and delivery person's terminal device by at least one step of:
a) using the barcode scanner of the package security device to read the unique barcode of the delivery person's terminal device;
b) using the radio-frequency identification sensor of the package security device to sense the unique radio-frequency identification of the delivery person's terminal device;
c) using the delivery person's terminal device to read the unique barcode of the package security device as described in claim 10;
d) using the delivery person's terminal device to sense the unique radio-frequency identification of the package security device as described in claim 11; or
e) using the package camera module of the package security device to recognize the barcode of the delivered package that matches the barcode in the notice of expected package delivery as described in claim 14.

19. A method of communication between the package security device and delivery person's terminal device comprising at least one step of:
a) the delivery person's terminal device sending to the package security device the information of the delivered package comprising track number of this shipment, barcode of the package, and brief description of the content inside the package; or
b) the package security device sending to the delivery person's terminal device the package delivery confirmation message comprising a picture of the delivered package.

20. A method of package security device monitoring the delivered package comprising at least one step of:
a) ordering the package camera module to take pictures at certain frequency of time;
b) activating the buzzer to beep for some period of time when the package security device finds appreciable changes in the package camera module's viewing area; or
c) storing pictures having the appreciable changes as the proof for police office.
